(19) United States
(12) Patent Application Publication
(10) Pub. No.: US 2019/0078292 A1
(43) Pub. Date: Mar. 14, 2019

(54) WORK VECHILE

(71) Applicant: KOMATSU LTD., Minato-ku, Tokyo (JP)

(72) Inventor: Yutaka ONO, Minato-ku, Tokyo (JP)

(73) Assignee: KOMATSU LTD., Minato-ku, Tokyo (JP)

(21) Appl. No.: 16/082,633

(22) PCT Filed: Mar. 3, 2017
(86) PCT No.: PCT/JP2017/008527

§ 371 Date: Sep. 6, 2018

(30) Foreign Application Priority Data
Mar. 23, 2016 (JP) 2016-058838

(51) Int. Cl. E02F 3/84; G01C 3/08; G01C 7/04; E02F 3/76

(52) U.S. Cl. CPC E02F 3/845; G01C 3/08; B62D 49/08; E02F 3/7627; G01C 7/04

(57) ABSTRACT

A work vehicle capable of accurately obtaining current topography to be worked is provided. A motor grader includes a vehicular body frame, a blade, and a camera. The blade is arranged between a front end of the vehicular body frame and a rear end of the vehicular body frame. The camera is configured to obtain current topography in front of the vehicular body frame. The camera is attached to the vehicular body frame. The camera is arranged in front of the blade.

### TECHNICAL FIELD

The present invention relates to a work vehicle.

### BACKGROUND ART

A motor grader has conventionally been known as a work vehicle. The motor grader is a wheeled work vehicle which grades road surfaces or grounds to a smooth state. US Patent Application Publication No. 2014/0170617 (PTD 1) discloses a motor grader in which an operator's cab is mounted on a vehicular body frame and a camera is mounted on a ceiling of the operator's cab.

US Patent Application Publication No. 2010/0046800 (PTD 2) discloses a work vehicle including a scanner which successively measures distances to a number of points on the ground.

### CITATION LIST

### Patent Document

### PTD 1: US Patent Application Publication No. 2014/0170617

### PTD 2: US Patent Application Publication No. 2010/0046800

### SUMMARY OF INVENTION

### Technical Problem

In order to improve productivity in executing operations in a construction project, current topography to be worked should accurately and efficiently be measured, and execution of an object to be worked should be done based on both of design topography representing a target shape of the object to be worked and the current topography.

An object of the present invention is to provide a work vehicle capable of accurately obtaining current topography to be worked.

### Solution to Problem

In general, in a motor grader, a blade is arranged between a front end and a rear end of a vehicular body frame. A front wheel is arranged in front of the blade. When the motor grader travels forward, the front wheel moves past the ground before the blade grades the ground. When the front wheel moves past the ground with projections and recesses, a position of the blade is varied in an upward/downward direction in correspondence with the projections and recesses in the ground. Specifically, when the front wheel moves past a projection, a position of the blade moves upward and the blade moves away from the ground, which results in insufficient land-grading works. When the front wheel moves past a recess, a position of the blade moves downward and the blade cuts into the ground. Consequently, the ground after the blade has moved past does not match with a design surface.

The present inventor has found that topography which the front wheel will move past should accurately be obtained in order to improve accuracy in execution of land-grading works with a motor grader, and completed the present invention.

A work vehicle according to the present invention includes a vehicular body frame, a blade, and a sensor. The blade is arranged between a front end of the vehicular body frame and a rear end of the vehicular body frame. The sensor is configured to obtain current topography in front of the vehicular body frame. The sensor is attached to the vehicular body frame. The sensor is arranged in front of the blade.

### Advantageous Effects of Invention

According to the present invention, topography which the front wheel will move past can accurately be obtained.

### BRIEF DESCRIPTION OF DRAWINGS

FIG. 1 is a perspective view schematically showing a construction of a motor grader based on a first embodiment.

FIG. 2 is a side view schematically showing the construction of the motor grader based on the first embodiment.

FIG. 3 is an enlarged perspective view of a tip end portion of a front frame of the motor grader shown in FIG. 2.

FIG. 4 is a schematic diagram showing an image pick-up range by a stereo camera.

FIG. 5 is an enlarged perspective view of the tip end portion of the front frame of the motor grader based on a second embodiment.

FIG. 6 is an enlarged perspective view of the tip end portion of the front frame of the motor grader based on the second embodiment.

FIG. 7 is a side view schematically showing a construction of the motor grader based on a third embodiment.

FIG. 8 is an enlarged perspective view of the tip end portion of the front frame of the motor grader shown in FIG. 7.

FIG. 9 is an enlarged perspective view of the tip end portion of the front frame of the motor grader based on a fourth embodiment.

FIG. 10 is a schematic diagram showing a range of scanning with radar.

### DESCRIPTION OF EMBODIMENTS

A work vehicle according to an embodiment of the present invention will be described below with reference to the drawings. The same elements have the same reference characters allotted in the description below and their labels and functions are also the same. Therefore, detailed description thereof will not be repeated.

### First Embodiment

A construction of a motor grader representing one example of a work vehicle to which the concept of the present invention is applicable will initially be described.

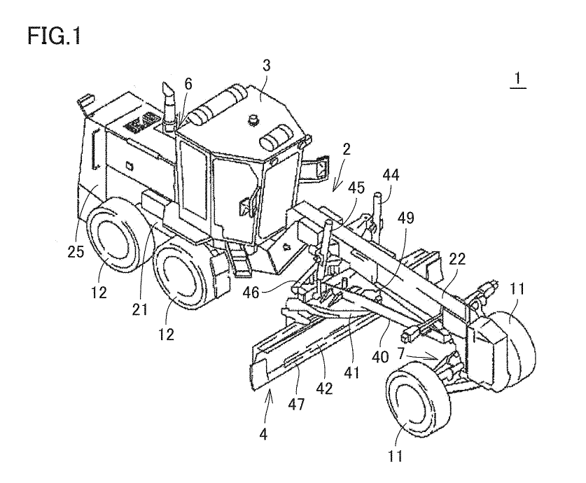

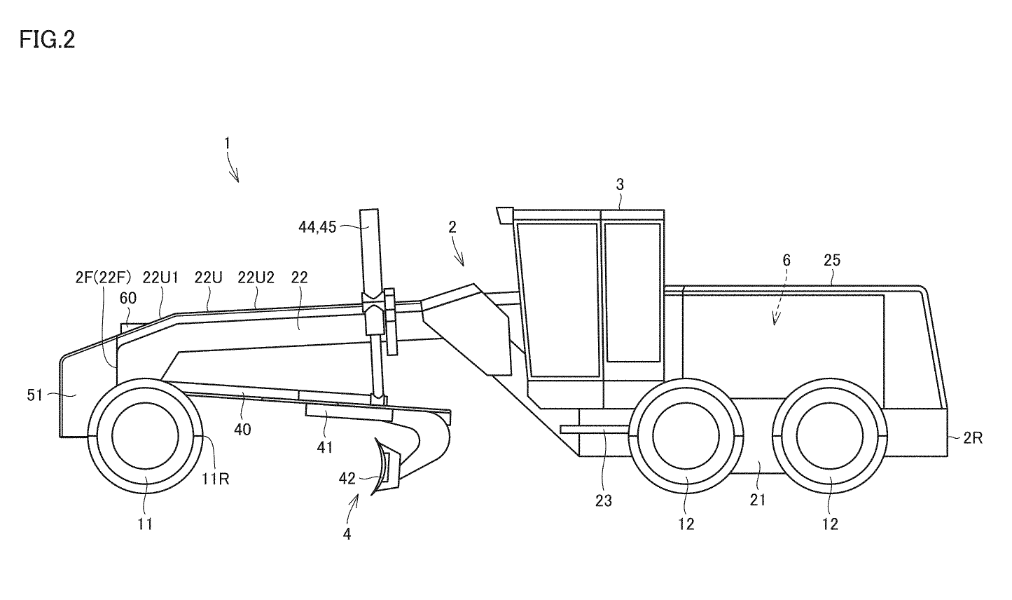

FIG. 1 is a perspective view schematically showing a construction of a motor grader 1 based on a first embodiment. FIG. 2 is a side view schematically showing the construction of motor grader 1 based on the first embodiment. As shown in FIGS. 1 and 2, motor grader 1 in the present embodiment mainly includes running wheels 11 and 12, a vehicular body frame 2, a cab 3, and a work implement 4. Motor grader 1 includes components such as an engine arranged in an engine compartment 6. Work implement 4 includes a blade 42. Motor grader 1 can do such works as land-grading works, snow removal works, light cutting, and mixing of materials with blade 42.

Running wheels 11 and 12 include a front wheel 11 and a rear wheel 12. Though FIGS. 1 and 2 show running wheels six in total which consist of two front wheels 11 one on each side and four rear wheels 12 two on each side, the number of front wheels and rear wheels and arrangement thereof are not limited to the example shown in FIGS. 1 and 2.

In the description of the drawings below, a direction in which motor grader 1 travels in straight lines is referred to as a fore/aft direction of motor grader 1. In the fore/aft direction of motor grader 1, a side where front wheel 11 is arranged with respect to work implement 4 is defined as the fore direction. In the fore/aft direction of motor grader 1, a side where rear wheel 12 is arranged with respect to work implement 4 is defined as the aft direction. A lateral direction of motor grader 1 is a direction orthogonal to the fore/aft direction in a plan view. A right side and a left side in the lateral direction in facing front are defined as a right direction and a left direction, respectively. An upward/downward direction of motor grader 1 is a direction orthogonal to the plane defined by the fore/aft direction and the lateral direction. A side in the upward/downward direction where the ground is located is defined as a lower side and a side where the sky is located is defined as an upper side.

The fore/aft direction refers to a fore/aft direction of an operator who sits at an operator's seat in cab 3. The lateral direction refers to a lateral direction of the operator who sits at the operator's seat. The lateral direction refers to a direction of a vehicle width of motor grader 1. The upward/downward direction refers to an upward/downward direction of the operator who sits at the operator's seat. A direction in which the operator sitting at the operator's seat faces is defined as the fore direction and a direction behind the operator sitting at the operator's seat is defined as the aft direction. A right side and a left side at the time when the operator sitting at the operator's seat faces front are defined as the right direction and the left direction, respectively. A foot side of the operator who sits at the operator's seat is defined as a lower side, and a head side is defined as an upper side.

Front wheel 11 includes a rearmost portion 11R. Rearmost portion 11R is a portion of front wheel 11 located rearmost.

Vehicular body frame 2 extends in the fore/aft direction (the lateral direction in FIG. 2). Vehicular body frame 2 includes a front end 2F in a foremost portion and a rear end 2R in a rearmost portion. Vehicular body frame 2 includes a rear frame 21 and a front frame 22.

Rear frame 21 supports an exterior cover 25 and components such as the engine arranged in engine compartment 6. Exterior cover 25 covers engine compartment 6. For example, each of four rear wheels 12 is attached to rear frame 21 as being rotatably driven by driving force from the engine.

Front frame 22 is attached in front of rear frame 21. Front frame 22 is pivotably coupled to rear frame 21. Front frame 22 extends in the fore/aft direction. Front frame 22 includes a base end portion coupled to rear frame 21 and a tip end portion opposite to the base end portion. The base end portion of front frame 22 is coupled to the tip end portion of rear frame 21 with a vertical central pin being interposed.

An articulation cylinder 23 is attached between front frame 22 and rear frame 21. Front frame 22 is provided as being pivotably with respect to rear frame 21 owing to extending and retracting of articulation cylinder 23. Articulation cylinder 23 is provided as being extensible and retractable in response to an operation of a control lever provided in cab 3.

Front frame 22 includes a front end 22F. Front end 22F is included in the tip end portion of front frame 22. For example, two front wheels 11 are rotatably attached to the tip end portion of front frame 22. Front wheel 11 is attached to front frame 22 as being revolvable owing to extending and retracting of a steering cylinder 7. Motor grader 1 can change its direction of travel owing to extending and retracting of steering cylinder 7. Steering cylinder 7 can extend and retract in response to an operation of a steering wheel or a steering control lever provided in cab 3.

Front frame 22 includes an upper surface 22U. Upper surface 22U includes a front upper surface 22U1 and a rear upper surface 22U2. Front upper surface 22U1 defines the upper surface of the tip end portion of front frame 22. Rear upper surface 22U2 defines the upper surface of the base end portion of front frame 22. Front upper surface 22U1 is inclined in an obliquely front downward direction. Front frame 22 includes an inclined region in which the upper surface is inclined in the obliquely front downward direction. Front upper surface 22U1 defines the upper surface of the inclined region.

A counter weight 51 is attached to front end 22F of front frame 22 (or front end 2F of vehicular body frame 2). Counter weight 51 represents one type of attachments to be attached to front frame 22. Counter weight 51 is attached to front frame 22 in order to increase a downward load to be applied to front wheel 11 to allow steering and to increase a pressing load on blade 42.

Cab 3 is carried on front frame 22. In cab 3, an operation portion (not shown) such as a steering wheel, a gear shift lever, a lever for controlling work implement 4, a brake, an accelerator pedal, and an inching pedal is provided. Cab 3 may be carried on rear frame 21.

Work implement 4 mainly includes a draw bar 40, a swing circle 41, and blade 42.

Draw bar 40 has a front end portion swingably attached to the tip end portion of front frame 22. Draw bar 40 has a rear end portion supported on front frame 22 by a pair of lift cylinders 44 and 45. Owing to extending, and retracting of lift cylinders 44 and 45, the rear end portion of draw bar 40 can move up and down with respect to front frame 22. Draw bar 40 is vertically swingable with an axis along a direction of travel of the vehicle being defined as the center, as a result of extending and retracting of lift cylinders 44 and 45. As a result of extending and retracting of a draw bar shift cylinder 46, draw bar 40 is movable laterally with respect to front frame 22.

Swing circle 41 is revolvably (rotatably) attached to the rear end portion of draw bar 40. Swing circle 41 can be driven by a hydraulic motor 49 as being revolvable clockwise and counterclockwise with respect to draw bar 40 when viewed from above the vehicle. As swing circle 41 is driven to revolve, an angle of inclination of blade 42 with respect to the fore/aft direction of motor grader 1 is adjusted. As swing circle 41 is driven to revolve, an angle of inclination of blade 42 with respect to a longitudinal direction of front frame 22 is adjusted.

Blade 42 is arranged between front wheel 11 and rear wheel 12. Blade 42 is arranged between front end 2F of vehicular body frame 2 (or front end 22F of front frame 22) and rear end 2R of vehicular body frame 2. Blade 42 is supported on swing circle 41. Blade 42 is supported on front frame 22 with swing circle 41 and draw bar 40 being interposed.

Blade 42 is supported as being movable in the lateral direction with respect to swing circle 41. Specifically, a blade shift cylinder 47 is attached to swing circle 41 and blade 42 and arranged along a longitudinal direction of blade 42. With blade shift cylinder 47, blade 42 is movable in the lateral direction with respect to swing circle 41. Blade 42 is movable in a direction intersecting with the longitudinal direction of front frame 22.

Blade 42 is supported as being swingable around an axis extending in the longitudinal direction of blade 42 with respect to swing circle 41. Specifically, a not-shown tilt cylinder is attached to swing circle 41 and blade 42. As a result of extending and retracting of the tilt cylinder, blade 42 swings around the axis extending in the longitudinal direction of blade 42 with respect to swing circle 41, so that an angle of inclination of blade 42 with respect to the direction of travel of the vehicle can be changed.

As set forth above, blade 42 is constructed to be able to move up and down with respect to the vehicle, swing around the axis along the direction of travel of the vehicle, change an angle of inclination with respect to the fore/aft direction, move in the lateral direction, and swing around the axis extending in the longitudinal direction of blade 42, with draw bar 40 and swing circle 41 being interposed.

A camera 60 is fixed to upper surface 221J of front frame 22. Camera 60 is an image pick-up apparatus for picking up an image of a front region in front of the vehicular main body and obtaining current topography of the front region. Camera 60 is configured to be able to obtain current topography in front of vehicular body frame 2. Camera 60 can pick up an image of the ground in front of front wheel 11.

Camera 60 is attached to front frame 22, of front frame 22 and rear frame 21 which define vehicular body frame 2. Camera 60 is fixed to front upper surface 22U1 of front frame 22. Camera 60 is arranged at the tip end portion of front frame 22. Camera 60 is arranged in the inclined region of front frame 22. Camera 60 is arranged in front of cab 3. Camera 60 is arranged in front of blade 42. Camera 60 is arranged in front of lift cylinder 44. Camera 60 is arranged in front of rearmost portion 11R of front wheel 11.

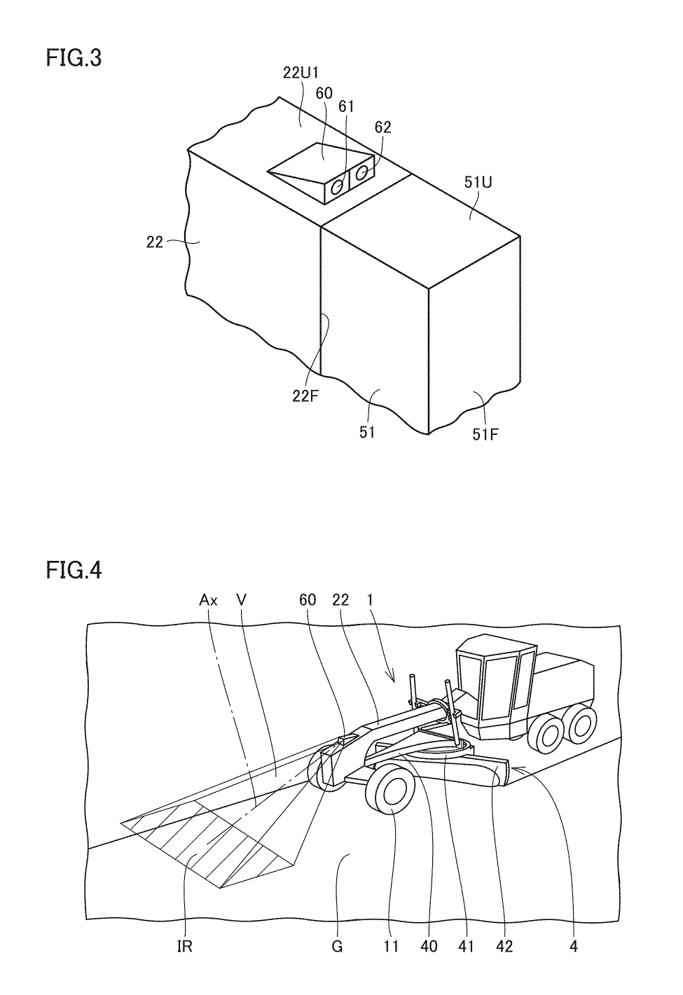

FIG. 3 is an enlarged perspective view of the tip end portion of front frame 22 of motor grader 1 shown in FIG. 2. FIG. 3 shows the tip end portion of front frame 22 when viewed from above the vehicular body from a right front direction. As shown in FIG. 3, camera 60 includes a first image pick-up portion 61 and a second image pick-up portion 62. First image pick-up portion 61 and second image pick-up portion 62 are in synchronization with each other and implement a stereo camera.

First image pick-up portion 61 and second image pick-up portion 62 are arranged at the same height. First image pick-up portion 61 and second image pick-up portion 62 are arranged as being aligned in the lateral direction. First image pick-up portion 61 is arranged on the right of second image pick-up portion 62 in the lateral direction. Second image pick-up portion 62 is arranged on the left of first image pick-up portion 61 in the lateral direction. First image pick-up portion 61 and second image pick-up portion 62 are apparatuses identical in type.

Each image pick-up portion includes an optical processing unit, a light reception processing unit, and an image processing unit. The optical processing unit includes a lens for gathering light. An optical axis of the image pick-up portion passes through the center of a lens surface and is perpendicular to the lens surface. The light reception processing unit includes an image pick-up device. The image pick-up device is implemented, for example, by a CMOS. The image pick-up device has a light reception surface. The light reception surface is orthogonal to the optical axis of the image pick-up portion. The light reception surface is flat and rectangular.

FIG. 4 is a schematic diagram showing an image pick-up range by the stereo camera. An optical axis AX shown with a chain dotted line in FIG. 4 represents the optical axis of camera 60. Optical axis AX forms an angle downward with respect to a horizontal direction in front of the vehicular main body of motor grader 1. Optical axis AX forms an angle of depression with respect to the horizontal direction in front of the vehicular main body.

A quadrangular pyramid in which camera 60 is located at a position of a vertex shown in FIG. 4 shows an angle of view V of camera 60. A hatched area in FIG. 4 shows an image pick-up range IR by camera 60. Camera 60 picks up an image of topography included in angle of view V. Camera 60 picks up an image of current topography within image pick-up range IR.

Motor grader 1 shown in FIG. 4 travels over ground G. Image pick-up range IR includes current topography in front of motor grader 1. Image pick-up range IR includes ground G in front of front wheel 11. Typically, image pick-up range IR includes ground G one- to three-meter in front of the vehicular body of motor grader 1. Image pick-up range IR includes topography which front wheel 11 will move past when motor grader 1 travels forward. Ground G of which image is to be picked up by camera 60 is ground G which front wheel 11 of motor grader 1 travelling forward will move past immediately after image pick-up. Camera 60 picks up an image of ground G which front wheel 11 will move past immediately before front wheel 11 moves past the ground.

First image pick-up portion 61 and second image pick-up portion 62 of camera 60 each pick up a two-dimensional image. By subjecting the two-dimensional images simultaneously picked up by first image pick-up portion 61 and second image pick-up portion 62 from different angles to stereo matching, image data involved with a three-dimensional shape of the front region which is an image pick-up target is calculated. More specifically, based on a parallax between first image pick-up portion 61 and second image pick-up portion 62, with principles of triangulation, a distance from first image pick-up portion 61 to image pick-up range IR and a distance from second image pick-up portion 62 to image pick-up range IR are calculated to find the three-dimensional shape of the front region.

Thus, the three-dimensional shape of topography in front of the vehicular main body is found by using camera 60. Since the three-dimensional shape of the topography which front wheel 11 will move past can accurately be obtained, highly accurate and highly efficient land-grading works can be done by utilizing data on the topography for operations of blade 42. For example, by showing data on the topography on a monitor provided in cab 3, an operator in cab 3 can accurately know the three-dimensional shape of the topography. Therefore, the operator can operate blade 42 taking into consideration movement of front wheel 11 in accordance with projections and recesses in the topography. Operations of blade 42 can also automatically be controlled based on the data on the topography.

Since displacement of a position of blade 42 from a design surface due to projections and recesses in current topography can be suppressed, accuracy in execution can be enhanced and topography after execution can be close to a design surface. Since the number of times of travel of motor grader 1 required for land-grading works can thus be decreased, time for execution can be reduced.

### Second Embodiment

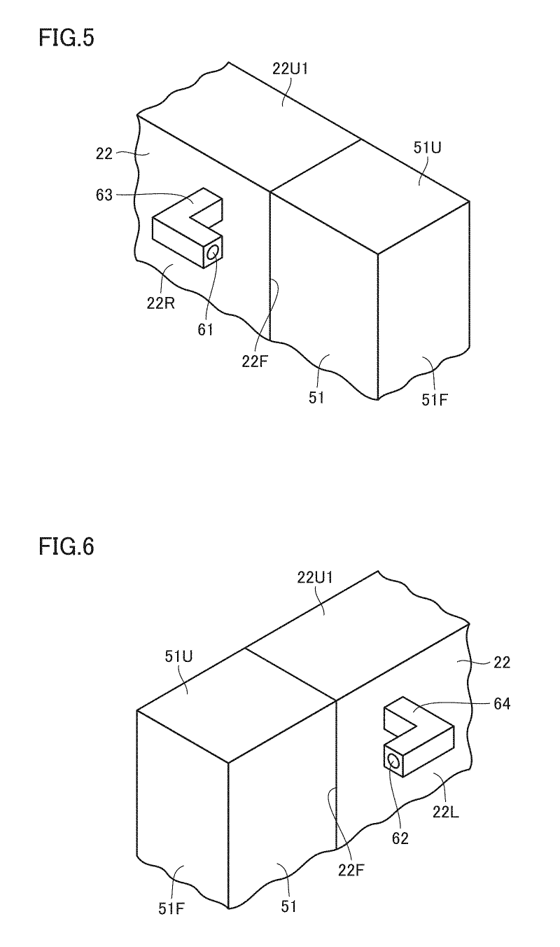

FIGS. 5 and 6 are enlarged perspective views of the tip end portion of front frame 22 of motor grader 1 based on a second embodiment. Though camera 60 is fixed to upper surface 22U of front frame 22 in the first embodiment described above, arrangement of camera 60 is not limited to this example. In the second embodiment, as shown in FIGS. 5 and 6, camera 60 is fixed to each of left and right sides of front frame 22. With cameras 60 thus arranged, a three-dimensional shape of topography in front of the vehicular main body which front wheel 11 will move past can accurately be obtained as in the first embodiment.

As shown in FIG. 5, front frame 22 includes a right surface 22R. A bracket 63 is fixed to right surface 22R. First image pick-up portion 61 is attached to a tip end of bracket 63.

As shown in FIG. 6, front frame 22 includes a left surface 22L. A bracket 64 is fixed to left surface 22L. Second image pick-up portion 62 is attached to a tip end of bracket 64.

In order to enhance accuracy of image pick-up data resulting from image pick-up by the stereo camera, based on the principles of triangulation, an interval between two image pick-up portions implementing the stereo camera is desirably increased. In the second embodiment, first image pick-up portion 61 and second image pick-up portion 62 are arranged at a distance from each other in the lateral direction. Therefore, accuracy of image pick-up data from camera 60 is improved. Since an image of current topography in front of vehicular body frame 2 can accurately be picked up, highly accurate and highly efficient land-grading works can be done by utilizing data on the topography for operations of blade 42.

### Third Embodiment

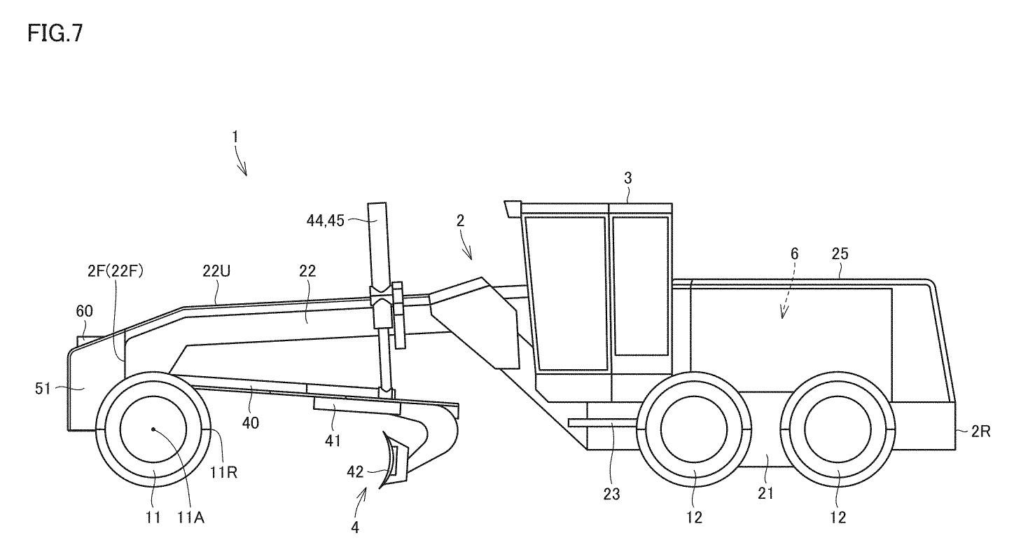

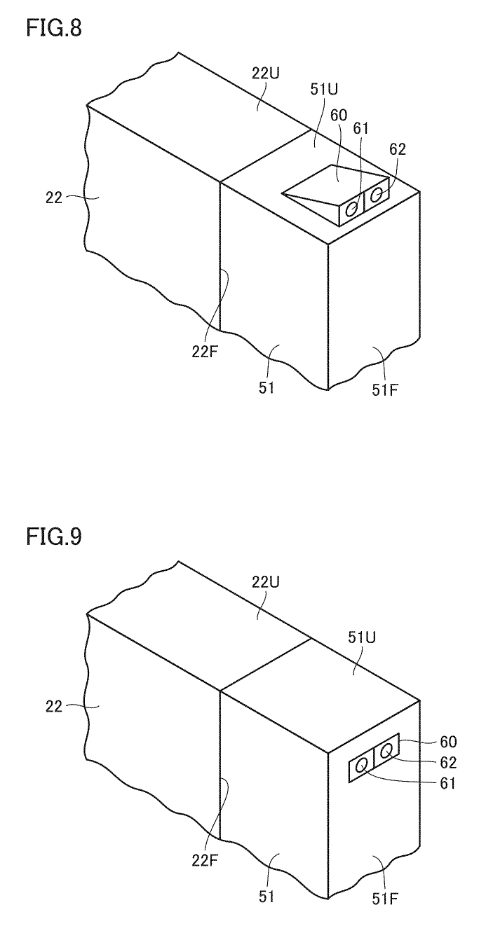

FIG. 7 is a side view schematically showing a construction of motor grader 1 based on a third embodiment. FIG. 8 is an enlarged perspective view of the tip end portion of front frame 22 of motor grader 1 shown in FIG. 7. Though camera 60 is directly fixed to upper surface 22U of front frame 22 in the first embodiment described above, arrangement of camera 60 is not limited to this example. Camera 60 may be fixed to another apparatus or member fixed to front frame 22 and may indirectly be attached to front frame 22 with another apparatus or member being interposed.

As shown in FIGS. 7 and 8, camera 60 in the third embodiment is fixed to counter weight 51 attached to front end 2F of vehicular body frame 2 (front end 22F of front frame 22). Counter weight 51 includes an upper surface 51U and a front surface 51F as shown in FIG. 8.

Camera 60 in the third embodiment is fixed to upper surface 51U of counter weight 51. Camera 60 includes first image pick-up portion 61 and second image pick-up portion 62 described in the first embodiment. Camera 60 is arranged in front of a rotation shaft 11A serving as a center of rotation of front wheel 11. Camera 60 is arranged in front of front end 2F of vehicular body frame 2 (front end 22F of front frame 22).

With camera 60 thus arranged, a three-dimensional shape of topography in front of the vehicular main body which front wheel 11 will move past can accurately be obtained as in the first embodiment. By arranging camera 60 on upper surface 51U of counter weight 51, camera 60 is arranged further forward as compared with the first embodiment. Therefore, a component of motor grader 1 is less likely to be present within angle of view V (FIG. 4) of camera 60. Since a wider area of the ground in front of vehicular body frame 2 can be included in image pick-up range IR by camera 60, a three-dimensional shape of topography in front of the vehicular main body which front wheel 11 will move past can reliably be obtained.

### Fourth Embodiment

FIG. 9 is an enlarged perspective view of the tip end portion of front frame 22 of motor grader 1 based on a fourth embodiment. As in the third embodiment, camera 60 is fixed to counter weight 51 attached to front end 2F of vehicular body frame 2 (front end 22F of front frame 22). Camera 60 in the fourth embodiment is arranged as being embedded in counter weight 51. The optical processing units of first image pick-up portion 61 and second image pick-up portion 62 are exposed at front surface 51F of counter weight 51.

With camera 60 thus arranged, a three-dimensional shape of topography in front of the vehicular main body which front wheel 11 will move past can accurately be obtained as in the first embodiment. Since camera 60 is arranged as being exposed at front surface 51F of counter weight 51, camera 60 is arranged further forward as compared with the first embodiment. Therefore, a component of motor grader 1 is less likely to be present within angle of view V (FIG. 4) of camera 60. Since a wider area of the ground in front of vehicular body frame 2 can be included in image pick-up range IR by camera 60, a three-dimensional shape of topography in front of the vehicular main body which front wheel 11 will move past can reliably be obtained.

In motor grader 1, counter weight 51 is provided to increase a downward load to be applied to front wheel 11. When a heavy attachment such as a scarifier is attached to front frame 22, however, counter weight 51 may not be attached to front frame 22. In such a case, as described in the first and second embodiments, camera 60 may be fixed to front frame 22.

### Fifth Embodiment

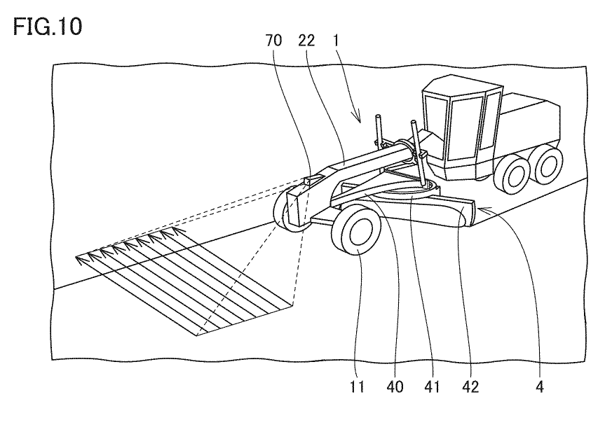

FIG. 10 is a schematic diagram showing a range of scanning with radar. In the embodiments described so far, an example in which motor grader 1 includes camera 60 for image pick-up of current topography is described. Instead of this example, motor grader 1 may include radar 70 which scans current topography as shown in FIG. 10.

In this case, by scanning the ground with radar 70, a three-dimensional shape of topography in front of the vehicular main body which front wheel 11 will move past can accurately be obtained. Since the three-dimensional shape of topography which front wheel 11 will move past can accurately be obtained, highly accurate and highly efficient land-grading works can be done by utilizing data on the topography for operations of blade 42.

A function and effect of the embodiments described above will now be described.

Motor grader 1 representing one example of the work vehicle in the embodiments includes vehicular body frame 2 and blade 42 as shown in FIG. 2. Vehicular body frame 2 includes front frame 22 and rear frame 21. Blade 42 is arranged between front end 2F of vehicular body frame 2 and rear end 2R of vehicular body frame 2.

Motor grader 1 further includes a sensor configured to obtain current topography in front of vehicular body frame 2. As shown in FIGS. 2 and 3, the sensor may be camera 60 which picks up an image of current topography. Alternatively, as shown in FIG. 10, the sensor may be radar 70 which scans current topography. The sensor is attached to front frame 22. The sensor is arranged in front of blade 42.

Motor grader 1 in the embodiments can measure current topography in front of vehicular body frame 2 with the sensor. Since a shape of topography which front wheel 11 will move past can accurately be obtained, highly accurate and highly efficient land-grading works can be done by utilizing data on the topography for operations of blade 42.

As shown in FIGS. 3 and 5 to 6, the sensor is arranged at the tip end portion of front frame 22. By doing so, the sensor can be arranged at a position closer to the ground in front of vehicular body frame 2 of which current topography should be obtained with the sensor, and current topography in front of vehicular body frame 2 can more accurately be obtained. A component of motor grader 1 is less likely to be present within an angle of view of the sensor, and the component of motor grader 1 being an obstacle in obtaining current topography with the sensor is suppressed. The current topography over a wider area in front of vehicular body frame 2 can thus reliably be obtained.

As shown in FIG. 2, motor grader 1 further includes articulation cylinder 23 attached between front frame 22 and rear frame 21. By extending and retracting articulation cylinder 23, front frame 22 can pivot with respect to rear frame 21 and front frame 22 can bend with respect to rear frame 21. A slewing radius at the time of revolution of motor grader 1 can thus be smaller. In addition, works for excavating a groove and works for cutting a slope by offset running of motor grader 1 can be done. Offset running refers to linear travel of motor grader 1 by setting a direction of bending of front frame 22 with respect to rear frame 21 and a direction of revolution of front wheel 11 with respect to front frame 22 to directions opposite to each other.

As shown in FIGS. 2 and 7, motor grader 1 further includes front wheel 11 rotatably attached to front frame 22. The sensor is arranged in front of rearmost portion 11R of front wheel 11. By doing so, since current topography in front of front wheel 11 can reliably be obtained with the sensor, a shape of topography which front wheel 11 will move past can accurately be obtained.

As shown in FIG. 2, front frame 22 includes an inclined region in which upper surface 22U is inclined in an obliquely front downward direction. The sensor is arranged in the inclined region. By arranging the sensor by taking advantage of the inclined region, the sensor can readily be arranged. Since interference with a field of view of an operator in cab 3 by the sensor is suppressed, a wide field of view of the operator can be ensured.

As shown in FIGS. 2 to 4 and 10, the sensor is fixed to upper surface 22U of front frame 22. By fixing the sensor to upper surface 22U which is an uppermost position in front frame 22, current topography over a wider area in front of vehicular body frame 2 can reliably be obtained.

As shown in FIGS. 5 and 6, the sensor is fixed to each of left and right sides of front frame 22. By arranging the sensors at a distance from each other in the lateral direction, an image of current topography in front of vehicular body frame 2 can accurately be picked up.

As shown in FIGS. 7 to 9, motor grader 1 further includes counter weight 51 representing one example of attachments to be attached to front end 2F of vehicular body frame 2. The sensor is fixed to counter weight 51. By doing so, a component of motor grader 1 is less likely to be present within an angle of view of the sensor, and the component of motor grader 1 being an obstacle in obtaining current topography with the sensor is suppressed. Current topography over a wider area in front of vehicular body frame 2 can thus reliably be obtained.

Though motor grader 1 includes cab 3 in the embodiments described so far, motor grader 1 does not necessarily have to include cab 3. Motor grader 1 is not limited to such specifications that an operator is on board motor grader 1 to operate motor grader 1, but the specifications may be such that the motor grader is operated under external remote control. Since motor grader 1 does not require cab 3 for an operator to get on board in this case, motor grader 1 does not have to include cab 3.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 motor grader; 2 vehicular body frame; 2F, 22F front end; 2R rear end; 3 cab; 4 work implement; 11 front wheel; 11A rotation shaft; 11R rearmost portion; 12 rear wheel; 21 rear frame; 22 front frame; 22L left surface; 22R right surface; 22U, 51U upper surface; 22U1 front upper surface; 22U2 rear upper surface; 25 exterior cover; 40 draw bar; 41 swing circle; 42 blade; 44 lift cylinder; 51 counter weight; 51F front surface; 60 camera; 61 first image pick-up portion; 62 second image pick-up portion; 63, 64 bracket; 70 radar; AX optical axis; IR image pick-up range; and V angle of view

1. A work vehicle comprising:
a vehicular body frame;
a blade arranged between a front end of the vehicular body frame and a rear end of the vehicular body frame; and
a sensor attached to the vehicular body frame and arranged in front of the blade, the sensor being configured to obtain current topography in front of the vehicular body frame.

2. The work vehicle according to claim 1, wherein
the vehicular body frame includes a front frame and a rear frame, and
the sensor is attached to the front frame.

3. The work vehicle according to claim 2, the work vehicle further comprising an articulation cylinder attached between the front frame and the rear frame.

4. The work vehicle according to claim 2, the work vehicle further comprising a front wheel rotatably attached to the front frame, wherein
the sensor is arranged in front of a rearmost portion of the front wheel.

5. The work vehicle according to claim 2, wherein
the sensor is arranged at a tip end portion of the front frame.

6. The work vehicle according to claim 4, wherein
the front frame includes an inclined region in which an upper surface thereof is inclined in an obliquely front downward direction, and
the sensor is arranged in the inclined region.

7. The work vehicle according to claim 4, wherein
the sensor is fixed to an upper surface of the front frame.

8. The work vehicle according to claim 4, wherein
the sensor is fixed to each of left and right sides of the front frame.

9. The work vehicle according to claim 1, the work vehicle further comprising an attachment attached to the front end of the vehicular body frame, wherein
the sensor is fixed to the attachment.

10. The work vehicle according to claim 9, wherein
the attachment is a counter weight.

11. The work vehicle according to claim 1, wherein
the sensor is at least any one of a camera which picks up an image of the current topography and radar which scans the current topography.
